(19) United States
(12) Patent Application Publication
(10) Pub. No.: US 2026/0336818 A1
(43) Pub. Date: Oct. 29, 2026

(54) HYBRID ELECTRIC TURBINE ENGINE CONTROL SYSTEM

(71) Applicants: SAFRAN AIRCRAFT ENGINES, Paris (FR); SAFRAN ELECTRICAL & POWER, Blagnac (FR); GENERAL ELECTRIC DEUTSCHLAND HOLDING GMBH, Frankfurt (DE); GENERAL ELECTRIC COMPANY, Schenectady, NY (US)

(72) Inventors: Philippe DELBOSC, Blagnac (FR); Jean Philippe Pierre-Alain REIGNER, Paris (FR); Mohamed OSAMA, Frankfurt (DE); Darek ZATORSKI, Schenectady, NY (US)

(21) Appl. No.: 19/104,820

(22) PCT Filed: Aug. 24, 2022
(86) PCT No.: PCT/IB2022/000479

§ 371 Date: Feb. 19, 2025

(51) Int. Cl. B64D 31/18; B64D 27/33; B64D 27/35

(52) U.S. Cl. CPC B64D 31/18; B64D 27/33; B64D 27/35

(57) ABSTRACT

A first electric machine coupled to a low pressure shaft of the turbine engine and a second electric machine coupled to a high pressure shaft of the turbine engine. The turbine engine includes one or more engine loads and an external electrical connection for communicating electrical power between the turbine engine and an electrical system of an aircraft. The turbine engine includes a power management system including a high voltage DC busbar configured to communicate electrical power between the first and second electric machines and the engine loads and the external electrical connection. The power management system includes a control system configured to control power offtake from and injection to the first and second electric machines, and controls power delivered to the one or more engine loads and the external electrical connection.

### TECHNICAL FIELD

The invention relates to an electrical control system for a hybrid electric turbine engine. In particular, the invention relates to an electrical network and control system for an aircraft turbine engine having at least two turbine shafts, each connected with an electric machine.

### BACKGROUND OF THE INVENTION

Aircraft require electrical power generation to sustain the engine electrical loads and the aircraft electrical loads. Such power can be provided by a turbomachine. Turbofans are generally equipped with a generator, typically an integrated drive generator or a variable frequency generator, which typically takes power off the high pressure shaft. Sometimes, the power generator can act as a starter generator, such as a variable frequency starter generator. In turboprops, power for the aircraft can be extracted using an electric machine connected to the low pressure shaft or the propeller shaft, instead of the high pressure shaft.

There exists a need for an improved turbine engine.

### SUMMARY OF THE INVENTION

According to one aspect, the invention provides a turbine engine comprising any or all of the following features:
a first electric machine coupled to a low pressure (LP) shaft of the turbine engine;
a second electric machine coupled to a high pressure (HP) shaft of the turbine engine;
one or more engine loads;
an external electrical connection for communicating electrical power between the turbine engine and an electrical system of an aircraft; and
a power management system comprising:
   a high voltage DC busbar configured to communicate electrical power between the first and second electric machines, the one or more engine loads and the external electrical connection; and
   a control system configured to control power offtake from and injection to the first and second electric machines, and to control power delivered to the one or more engine loads and the external electrical connection.

This arrangement provides an electrical power system architecture capable of powering all the aircraft and the engine loads, controlling the power extraction between the HP and LP shafts within the turbine engine, and allowing the injection of power on one of the two shafts of the turbomachine without the need for an external source of power. By paralleling multiple DC electrical sources, it is possible to control the distribution of the electrical power offtake on the LP and HP shafts of the turbomachine, or even to reverse the direction of the power flow to allow power transfer between shafts. As a skilled person will be aware, high voltage in the context of commercial aeronautics refers to a voltage level between 540 VDC and 1500 VDC. This arrangement is particularly applicable as an architecture for high power direct current electrical systems in response to the operational scenarios identified for a hybrid propulsion system, but this architecture is also applicable to any type of turbomachine equipped with at least two shafts (i.e., a LP and HP shaft). This addresses the issue with current offtake solutions (typically via an integrated drive generator or a variable frequency generator) that do not allow the functions mentioned above to be carried out, namely splitting the offtake on the shafts and transferring power from one shaft to the other. This provides the advantage of energy independence of the propulsion system. Furthermore, this arrangement does not rely on the use of mechanical power transfer or power split devices, such as differentials or clutch mechanisms.

The first and second electric machines may each comprise a plurality of windings. The windings may be multiphase windings. The windings may be connected to control electronics. The control electronics may include a rectifier and/or inverter to convert between AC and DC voltage. The control system may be configured to control operating parameters of the first and second electric machines. The power management system may comprise electrical protection devices, such as breakers.

The turbine engine may comprise a third electric machine coupled to the LP shaft. The turbine engine may comprise a fourth electric machine coupled to the HP shaft. The turbine engine may comprise a second busbar. The second busbar may be configured to communicate electrical power between the third and fourth electric machines.

The high voltage DC busbar may be electrically connected to the second busbar. The turbine engine may comprise a second external electrical connection. The second external electrical connection may be configured to communicate electrical power between the turbine engine and the electrical system of the aircraft. The second busbar may be configured to communicate electrical power between the third and fourth electric machines, the engine loads and the second external electrical connection. The external electrical connector may be electrically connected to the second external electrical connector.

The control system may comprise a LP drive control unit. The LP drive control unit may be configured to regulate electrical currents of the first electric machine and/or to provide monitoring and electrical protection to the first electric machine. The control system may also comprise a HP drive control unit. The HP drive control unit may be configured to regulate electrical currents of the second electric machine and/or to provide monitoring and electrical protection to the second electric machine. The control system may further comprise a network and distribution control unit. The network and distribution control unit may be configured to regulate network voltage. The network and distribution control unit may be configured to apply power offtake orders and/or power injection orders received from an engine controller of the turbine engine. The network and distribution control unit may be arranged to configure the network and load supply management, and may be configured to monitor electrical loads and currents in the networks and/or to protect the network from over loading or from over-currents.

Alternatively, the control system may comprise a LP drive control unit and a HP drive control unit as defined above, and a voltage and power control unit. The voltage and power control unit may be configured to regulate the network voltage and may be configured to apply power offtake orders and power injection orders received from an engine controller of the turbine engine.

Alternatively, the control system may comprise the LP drive control unit and the HP drive control unit as mentioned above, wherein regulation of the network voltage and/or application of power offtake orders and power injection orders received from an engine controller of the turbine engine is/are provided by at least one of the LP drive control unit and the HP drive control unit.

The control system may comprise a network and distribution control unit. The network and distribution control unit may be arranged to configure the network and load supply management, and to monitor and protect the network. Advantageously, the above control systems are particularly suited to providing power balance and power transfer operating modes as defined later.

The HP drive control unit may be configured to directly communicate with the engine controller. Such communication may be via the voltage and power control unit, or may instead be via a connection which bypasses the voltage and power control unit. This embodiment is particularly advantageous for the engine start operating mode.

The control system may comprise an engine start operating mode. In the engine start operating mode, the control system may be configured to supply power from the external electrical connection to at least one of the first and second electric machines via the high voltage DC busbar. The control system may be configured to interrupt the power transfer between the first electric machine and the high voltage DC busbar when in the engine start operating mode. Furthermore, the control system may be configured to supply power to the engine loads when in the engine start operating mode.

The control system may comprise a power balance operating mode. The control system may be configured to direct, via the high voltage DC busbar, electrical power from the first and second electric machines to the engine loads, and preferably to the external electrical connection, when in the power balance operating mode.

The control system may comprise an engine restart operating mode. The control system may be configured to transfer power from the first electric machine to the high voltage DC busbar when in the engine restart operating mode. The control system may be configured to transfer power from the high voltage DC busbar to the second electric machine when in the engine restart operating mode. The control system may be configured to interrupt the power transfer between the high voltage DC busbar and the external electrical connection when in the engine restart operating mode. The control system may be configured to supply power to the engine loads when in the engine restart operating mode.

The control system may comprise a power transfer operating mode. The control system may be configured to transfer power from a first of the first electric machine and the second electric machine to a second of the first electric machine and the second electric machine, via the high voltage DC busbar when in the power transfer operating mode. The control system may be configured to transfer power from the high voltage DC busbar to the engine loads and/or the external electrical connection when in the power transfer operating mode.

The control system may be configured to be switchable between two or more of the group of four operating modes mentioned above. Preferably, the control system is configured to be switchable between three or four of the four operating modes defined above.

### BRIEF DESCRIPTION OF THE DRAWINGS

Further features and advantages of the present invention will become apparent from the following description of embodiments thereof, presented by way of example only, and by reference to the drawings, in which:

FIG. 1 is a schematic diagram of an electrical network in a turbine engine according to an embodiment;

FIG. 2 is a schematic diagram illustrating an operating mode of the network of FIG. 1;

FIG. 3 is a schematic diagram illustrating a further operating mode of the network of FIG. 1;

FIG. 4 is a schematic diagram illustrating a further operating mode of the network of FIG. 1;

FIG. 5 is a schematic diagram illustrating a further operating mode of the network of FIG. 1;

FIG. 6 is a schematic diagram of an electrical network in a turbine engine according to a further embodiment;

FIG. 7 is a schematic diagram of a control system of an electrical network in a turbine engine according to an embodiment;

FIG. 8 is a schematic diagram of a control system of an electrical network according to another embodiment;

FIG. 9 is a schematic diagram of a control system of an electrical network according to another embodiment;

FIG. 10 is a schematic diagram illustrating an operating mode of an electrical network according to an embodiment.

### DETAILED DESCRIPTION

The disclosure presented herein relates to a turbine engine for an aircraft. The turbine engine comprises at least two shafts, such as the low pressure (LP) and the high pressure (HP) shafts. Each of the LP and HP shafts is connected to an electric machine. The electric machine may be capable of acting as a motor and a generator, for example a permanent magnet generator (PMG). In this way, the LP and HP shafts can drive or be driven by the corresponding electric machines. When acting as a generator, the electric machines can produce multi-phase (typically three-phase) AC voltage, which can be rectified by an AC/DC converter associated with the electric machine. In this way, the electric machines can provide DC voltage. The DC voltage can be used to power engine loads, such as pumps and ice protection systems, and aircraft loads, for example heaters and in-flight entertainment systems.

A system is provided to control the power transfer between the shafts of the turbine engine and the aircraft and engine loads. The system provides a direct current (DC) network, which may be a high voltage direct current (HVDC) network, in order to parallelise the electrical sources. A system for controlling the HVDC network controls the power flow from or to each of these machines. In this context, “high voltage” means voltages in the range from 540 to 1500 VDC. The network includes a power management system including a busbar connected to the electric machines and the aircraft and engine loads. The control system is configured to manage the routing of power between the systems connected to the busbar depending on the operating parameters needed for various flight conditions.

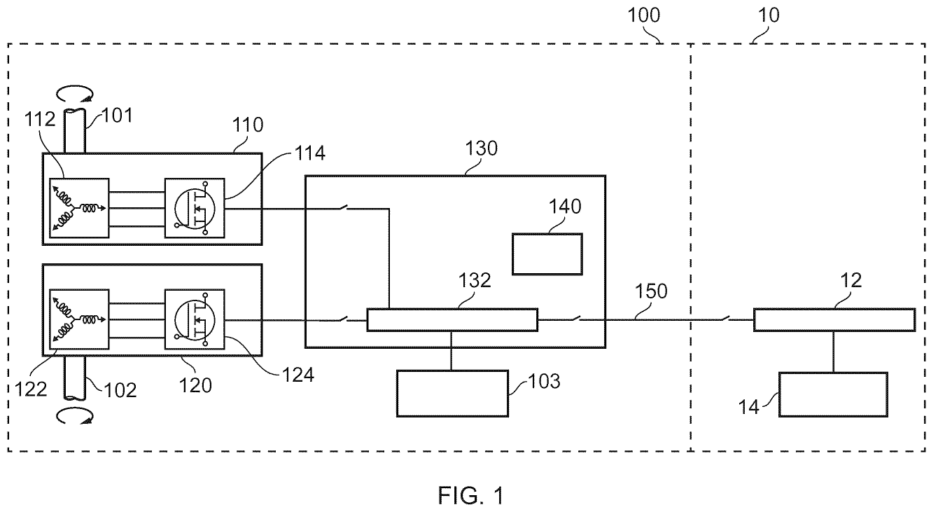

FIG. 1 illustrates an electrical network of a turbine engine 100 in an aircraft 10. In the arrangement shown, the turbine engine 100 comprises a LP shaft 101 connected to a first electric machine 112. The first electric machine 112 is configured to generate three phase AC voltage which can be converted into DC voltage by a first converter 114 connected to the first electric machine 112. The turbine engine 100 also comprises a HP shaft 102 connected to a second electric machine 122. The second electric machine 122 is connected to a second converter 124 configured to convert the three phase AC voltage into DC voltage, when the second electric machine 122 is acting as a generator.

The first electric machine 112 and the first converter 114 may be comprised in a LP drive channel 110. The second electric machine 122 and the second converter may be comprised in a HP drive channel 120. In the arrangement shown, the LP drive channel 110 and the HP drive channel 120 are electrically connected to a busbar 132. The busbar 132 is comprised in a power management system 130. The power management system 130 may be provided in the engine 100. In particular, the power management system 130 may be comprised within the perimeter of an integrated propulsion system of the aircraft 10. The busbar 132 is connected to engine loads 103. The busbar 132 is connected to an electrical network 12 of the aircraft 10 via an external electrical connection 150. The electrical network 12 of the aircraft 10 is connected to aircraft loads 14. Any or all of the electrical connections mentioned herein may comprise protection devices such as breakers.

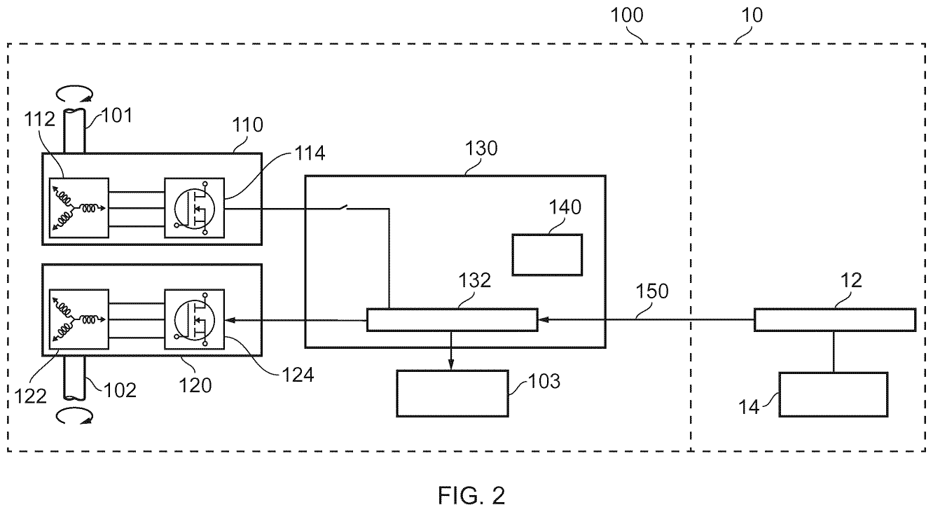

The power management system 130 comprises the busbar 132 which can be configured to communicate electrical power between the first and second electric machines 112, 122, and the one or more engine loads 103 and the external electrical connection 150. Furthermore, the power management system 130 comprises a control system 140. The control system 140 is configured to control power offtake from and injection to the first and second electric machines 112,122 and to control power delivered to the one or more engine loads 103 and the external electrical connection 150. The power management system 130 is configured to control the distribution of the electrical power offtake on the LP and HP shafts of the engine, and/or to reverse the direction of the power flow to allow power transfer between the LP and HP shafts. This is done by paralleling the at least two DC electrical sources generated by the LP drive channel 110 and the HP drive channel 120. This can be achieved by the control system 140 operating in and switching between several different operating modes. In FIGS. 2 to 5, such operating modes are illustrated by open switches representing interrupted electrical connections and by directional arrows representing the direction of power flow from one component to another.

FIG. 2 illustrates an engine start operating mode. The control system 140 may employ the engine start operating mode upon start up of the turbine engine. A power source external to the turbine engine, for example a power source provided in or via the aircraft 10, or directly to the engine, can be used to supply power to the busbar 132. The control system 140 can be configured to supply power from the external electrical connection 150 to at least one of the first and second electric machines 112,122 via the busbar 132. In the arrangement shown, the control system 140 is configured to interrupt the power transfer between the first electric machine 112 and the busbar 132. In this way, only the HP drive channel 120 is supplied with power. Furthermore, in the arrangement shown, the control system 140 is configured to supply power to the engine loads 103. The engine start operating mode illustrated in FIG. 2 is an operating mode that uses an electrical source external to the turbine engine 100. In this mode, the second electric machine 122 in the HP drive channel 120 operates in motor mode, wherein the electrical supply provided by the external source is used to provide torque on the HP shaft.

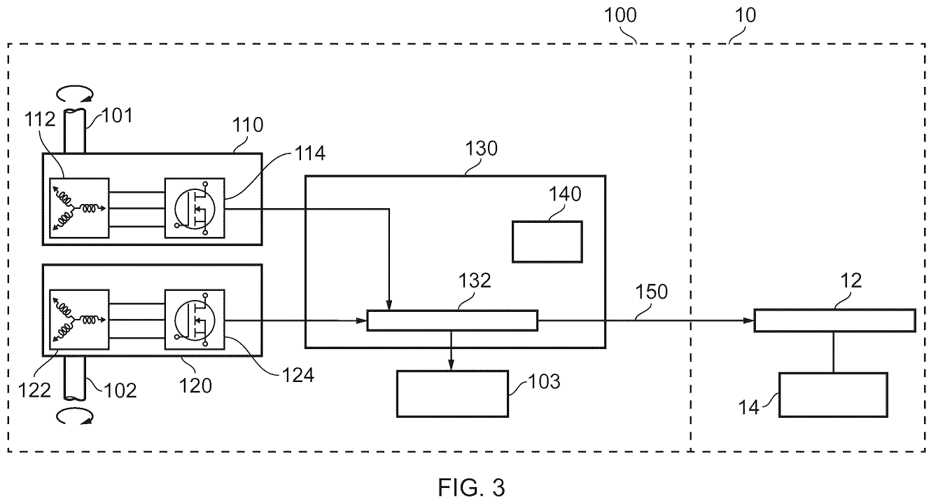

FIG. 3 illustrates a power balance operating mode of the control system 140. In the power balance operating mode, the control system 140 is configured to direct electrical power from the first and second electric machines 112,122 to the engine loads 103 and the external electrical connection 150, via the busbar 132. In this operating mode, both the first and second electric machines 112,122 operate in generator mode, wherein rotation of the turbine generates three phase AC voltage, which is converted by the first and second converters 114,124 into DC voltage for supply to the electrical network via the busbar 132. This operating mode allows the control system 140 to control the power split between the LP and HP drive channels 110,120 to supply engine loads 103 and aircraft loads 14, via the external electrical connection 150.

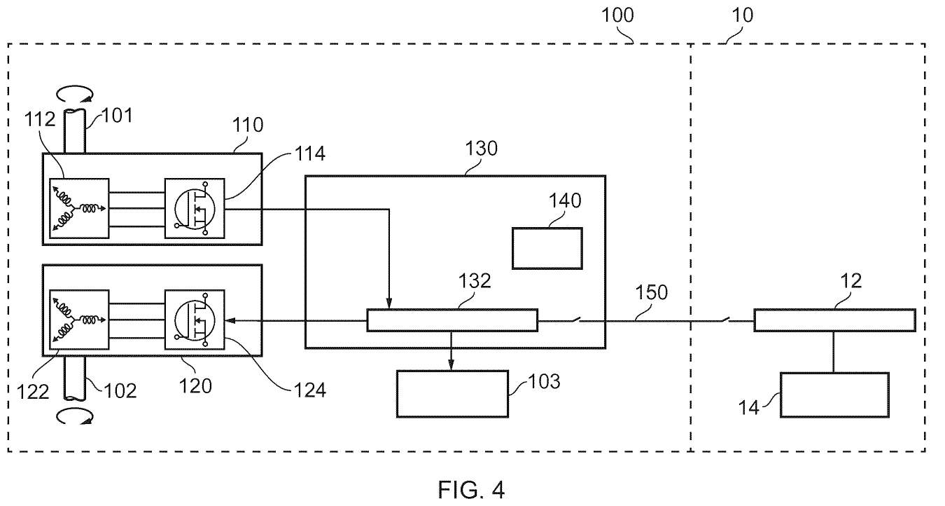

FIG. 4 illustrates an engine restart operating mode of the control system 140. In this operating mode, the control system 140 is configured to transfer power from the first electric machine 112 to the busbar 132 and to transfer power from the busbar 132 to the second electric machine 122. In this operating mode, the control system may be configured to interrupt the power transfer between the busbar 132 and the external electrical connection 150. Furthermore, the engine restart operating mode may allow the control system to supply power to the engine loads 103. This operating mode may be appropriate during in-flight restart such as when the turbine is windmilling. The first electric machine 112 in the LP drive channel 110 may generate electrical power despite the low drive speed. This electrical power can be used to supply the second electric machine 122 in the HP drive channel 120 in addition to engine loads 103, for example an electric fuel pump. In this mode, the first electric machine 112 operates as a generator while the second electric machine 122 operates as a motor, wherein the electrical power supplied to the HP drive channel 120 is used to drive the HP shaft in order to start the turbine, for example. This has the advantage of extending the engine's autonomous restart flight envelope.

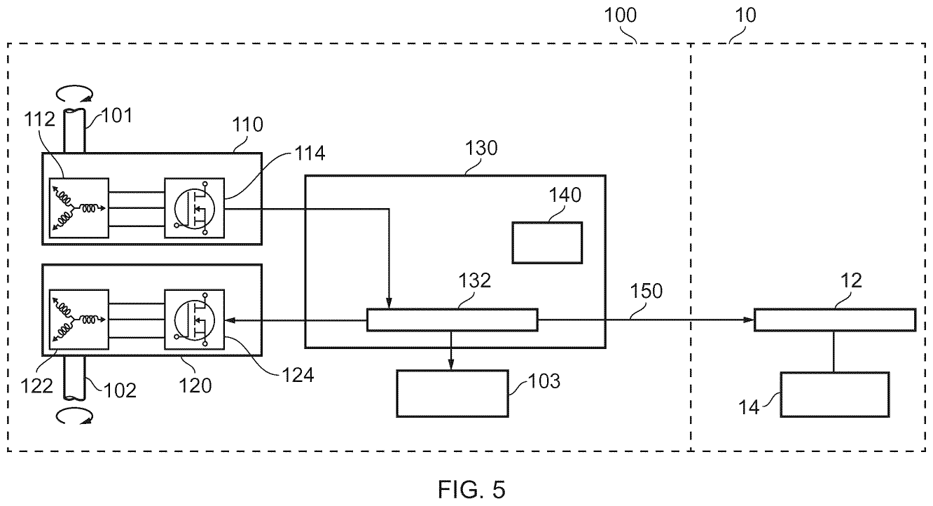

FIG. 5 illustrates a power transfer operating mode of the control system 140. In this operating mode, the control system 140 is configured to transfer power from one of the first electric machine and the second electric machine 112,122, to the other of the first electric machine and the second electric machine 112,122, via the busbar 132. For example, in the arrangement shown, the control system 140 is configured to transfer power from the LP drive channel 110 to the HP drive channel 120, via the busbar 132. In an alternative scenario, this operating mode may be configured to transfer power from the HP drive channel 120 to the LP drive channel 110, via the busbar 132. Furthermore, the control system 140 may be configured to transfer power from the busbar 132 to the engine loads 103 and/or the external electrical connection 150. In this mode, one of the drive channels 110,120 switches to motor mode to provide electrical assistance to its associated shaft. For example, in the illustrated arrangement wherein the LP drive channel 110 supplies electrical power to the HP drive channel 120, the second electric machine 122 operates in motor mode to provide rotational drive to the HP shaft. Meanwhile, the LP drive channel 110 continues to provide electrical power to the other loads in the network, such as the engine loads 103 and loads connected to the external electrical connection 150, such as the aircraft loads 14. In order to avoid overloading the electric machine operating in generator mode, the control system 140 may be configured to temporarily stop supplying non-critical engine or aircraft functions with electrical power.

The control system 140 may be configured to be switchable between any of the above-mentioned operating modes. For example, the control system 140 may be configured to be switchable between two or more of the four operating modes mentioned above. In this way, the control system 140 can control the power offtake from and power intake to the electric machines, while providing a power supply to the engine loads 103 and the aircraft loads 14 as required by the flight conditions.

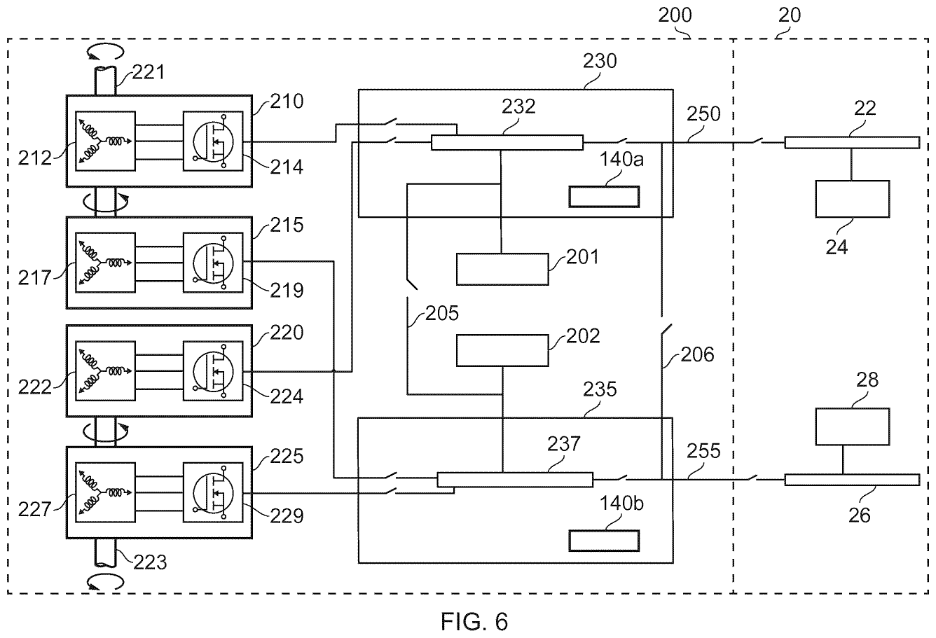

FIG. 6 illustrates an alternative embodiment of a turbine engine 200 of an aircraft 20 having an electrical network. The engine 200 comprises a LP shaft 221 and a HP shaft 223. The engine 200 comprises two LP drive channels 210,215. The first LP drive channel 210 comprises a first electric machine 212 and a first converter 214 while the second LP drive channel 215 comprises a third electric machine 217 and a third converter 219. Both the first and third electric machines 212,217 associated with the LP drive channels 210,215 can be driven by the same LP shaft in the engine 200.

The engine further comprises two HP drive channels 220,225. The first HP drive channel 220 comprises a second electric machine 222 and a second converter 224, while the second HP drive channel 225 comprises a fourth electric machine 227 and a fourth converter 229. Both electric machines 222,227 associated with the HP drive channels 220,225 can be driven by the same HP shaft of the engine 200. The specifications of the electric machines 212,217,222,227 and the converters 214,219,224,229 may be similar to those that were described above in relation to FIGS. 1 to 5.

The engine 200 can comprise two power management systems 230,235. In the illustrated arrangement, each power management system comprises a busbar 232,237 and a control system 140a, 140b. The first power management system 230 comprises a first busbar 232 and a first control system 140a. The first busbar 232 is connected to the first LP drive channel 210 and the first HP drive channel 220. The first busbar 232 is also connected to first engine loads 201 and has a first external electrical connection 250 configured to be connected to a first electrical network 22 of the aircraft 20 in order to supply power to first aircraft loads 24. The first control system 140a is configured to control power offtake from and injection to the first and second electric machines 212,222 and to control power delivered to the engine loads 201 and the external electrical connection 250.

In FIG. 6, the second power management system 235 comprises a second busbar 237. The second busbar 237 is connected to the second LP drive channel 215 and the second HP drive channel 225. The second busbar 237 is also connected to second engine loads 202 and can comprise a second external electrical connection 255 to an electrical network 26 of the aircraft 20 in order to supply power to the second aircraft loads 28. The second control system 140b is configured to control power offtake from and injection to the third and fourth electric machines 217,227 and to control power delivered to the second engine loads 202 and the second external electrical connection 255.

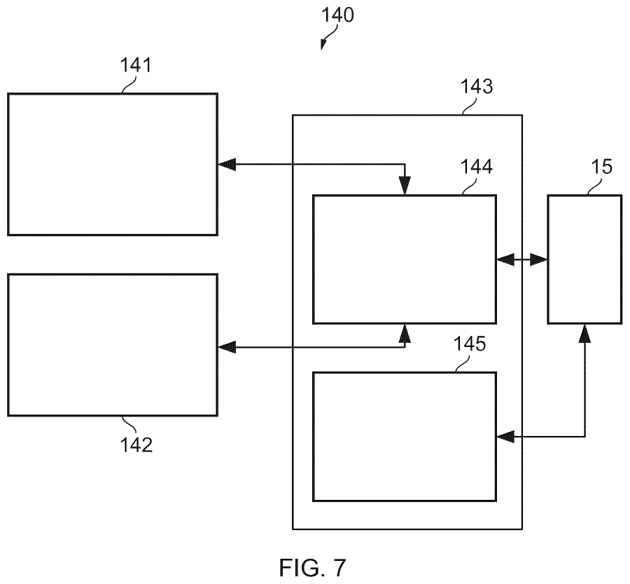

As shown in the example of FIG. 6, the electrical connection between the first busbar 232 and the first engine loads 201, and the electrical connection between the second busbar 237 and the second engine loads 202, may be respectively connected to each other by a bridge 205. In this way, the control systems 140a, 140b can be configured to allow the first busbar 232 to supply power to the second engine loads 202, and/or to allow the second busbar 237 to supply power to the first engine loads 201. This provides the possibility of powering both engine loads 201,202 even if one of the drive channels were to fail. In this regard, each power management system 230,235 may comprise its own control system 140a, 140b as shown in FIG. 6. The control systems 140a, 140b may be of at least one of the types described below in relation to FIGS. 7 to 10. Alternatively, the power management systems 230,235 may be controlled by a single control system.

The first external electrical connection 250 and the second external electrical connection 255 may be connected by a second bridge 206. In this way, the first busbar 232 can be connected to the second aircraft loads 28 via the second bridge 206, while the second busbar 237 can be connected to the first aircraft loads 24 via the second bridge 206. In this way, the first and second control systems 140a, 140b may be configured to supply power from the first busbar 232 to the second aircraft loads 28 and may also be configured to supply power from the second busbar 237 to the first aircraft loads 24. Any of the aforementioned connections may comprise protection devices such as breakers, being controllable by the first and second control systems 140a, 140b.

FIG. 7 illustrates an embodiment of a control system 140 for the power management system of the turbine engine. The control system 140 comprises a network and distribution control unit 143. The network and distribution control unit 143 is connected to the electronic engine controller (EEC) of the full authority digital engine control (FADEC). In the arrangement shown, the control system 140 includes a LP drive control unit 141 and a HP drive control unit 142. The LP and HP drive control units 141,142 can be configured to regulate the electrical currents and provide various monitoring and protection. It will be appreciated however that the control units 141,142 may instead be part of the electric machines of the LP drive channel and the HP drive channel respectively or may instead be located somewhere between the electric machines and the network and distribution control unit 143 and the control system 140. In the arrangement shown, the LP and HP drive control units 141,142 are connected to a module 144 of the network and distribution control unit 143 configured to regulate the network voltage and apply power offtake and injection orders from the FADEC 15. In this way, the module 144 can regulate and communicate instructions to the LP and the HP drive control units 141,142. Furthermore, the network and distribution control unit 143 may comprise a module 145 arranged to configure the network load power supply management, as well as monitor and protect the network.

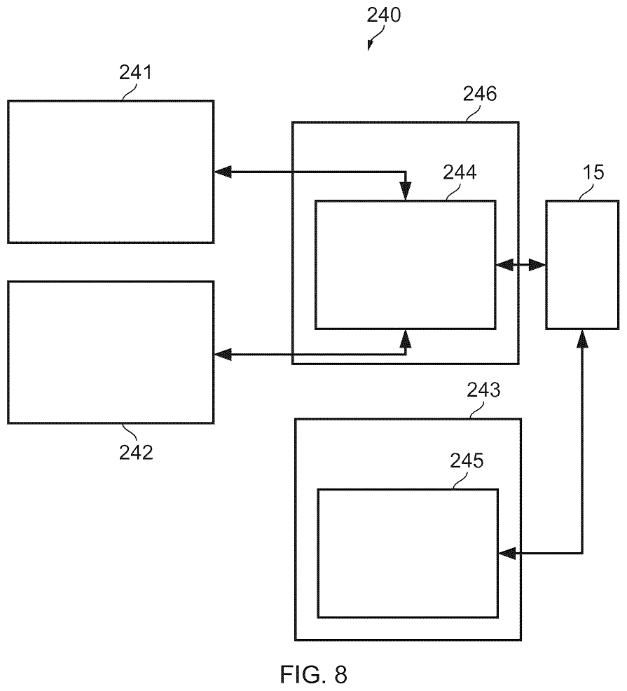

FIG. 8 illustrates another embodiment of a control system 240. The control system 240 comprises a voltage and power control unit 246 and a network and distribution control unit 243. The control system may further comprise a LP drive control unit 241 and a HP drive control unit 242. The LP and HP drive control units 241,242 can be configured to regulate the electrical currents and provide various monitoring and protection. The voltage and power control unit 246 comprises a module 244 configured to regulate the network voltage and apply power offtake and injection orders from the FADEC 15. The module 244 can be connected to the LP and HP drive control units 241,242 so as to communicate therewith. The network and distribution control unit 243 can comprise a module 245 arranged to configure the network and load power supply management and provide network monitoring and protection. The module 245 can be connected to the FADEC 15.

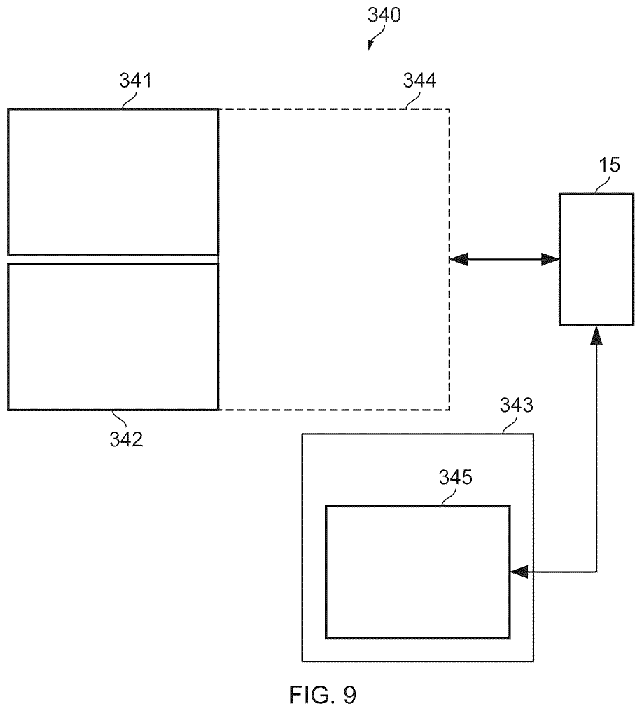

FIG. 9 illustrates another embodiment of a control system 340. The control system 340 comprises a network and distribution control unit 343. The network and distribution control unit 343 can comprise a module 345 arranged to configure the network and load power supply management and provide monitoring and protection. The module 345 is configured to communicate with the FADEC 15. The control system 340 can also comprise a LP drive control unit 341 and a HP drive control unit 342, each being configured to regulate the machine currents and provide various monitoring and protection. Instead of the control system including a separate module for the regulation of the network voltage and the application of the power offtake and injection orders from the FADEC 15, the control system 340 is configured such that these functions are provided by a voltage and power control unit 344 comprised in at least one of the LP drive control unit 341 and the HP drive control unit 342.

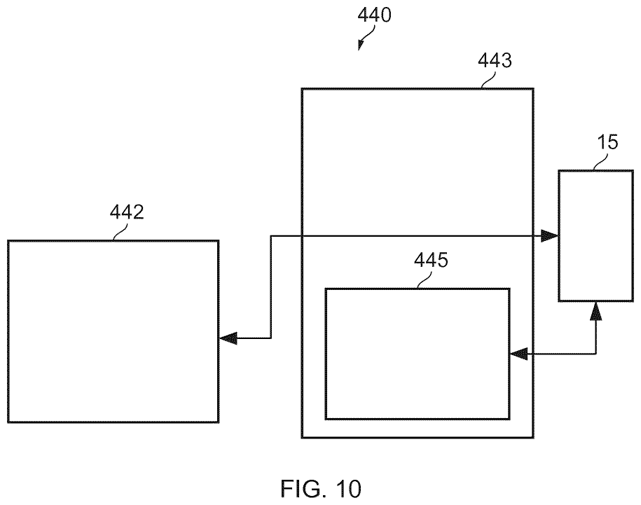

FIG. 10 illustrates a control system 440. The control system 440 comprises a network and distribution control unit 443. The network and distribution control unit 443 comprises a module 445 arranged to configure the network and load power supply management and to monitor and protect the network. The module 445 is configured to communicate with the FADEC 15. FIG. 10 illustrates an embodiment of a control system 440 when in the engine start operating mode. As such, the FADEC 15 can be directly connected to a HP drive control unit 442.

The control systems 140,240,340,440 can communicate with the FADEC 15 so as to: provide offtake capability limits (for example maximum offtake from each of the LP and HP shafts); provide proportional power offtake split command; provide the preferred power offtake source (i.e., LP or HP shaft); and/or provide any command of combined LP and HP offtakes according to control laws and feedback on the total power offtake (i.e. a feedback loop).

Various modifications, whether by way of addition, deletion and/or substitution, may be made to all of the above-described embodiments to provide further embodiments, any and/or all of which are intended to be encompassed by the appended claims.

1.-26. (canceled)

27. A turbine engine comprising:
a first electric machine coupled to a low pressure (LP) shaft of the turbine engine;
a second electric machine coupled to a high pressure (HP) shaft of the turbine engine;
one or more engine loads;
an external electrical connection for communicating electrical power between the turbine engine and an electrical system of an aircraft; and
a power management system comprising:
a high voltage DC busbar configured to communicate electrical power between the first and second electric machines, the one or more engine loads and the external electrical connection; and
a control system configured to control power offtake from and injection to the first and second electric machines, and to control power delivered to the one or more engine loads and the external electrical connection.

28. The turbine engine according to claim 27, wherein the control system is configured to control operating parameters of the first and second electric machines, wherein the power management system comprises electrical protection devices, and wherein the turbine engine further comprises a third electric machine coupled to the LP shaft and a fourth electric machine coupled to the HP shaft.

29. The turbine engine according to claim 28, further comprising a second busbar configured to communicate electrical power between the third and fourth electric machines, and wherein the high voltage DC busbar is electrically connected to the second busbar.

30. The turbine engine according to claim 29, further comprising a second external electrical connection for communicating electrical power between the turbine engine and the electrical system of the aircraft, wherein the second busbar is configured to communicate electrical power between the third and fourth electric machines and the engine loads and the second external electrical connection, and wherein the external electrical connection is electrically connected to the second external electrical connection.

31. The turbine engine according to claim 27, wherein the control system comprises:
a LP drive control unit configured to regulate electrical currents of the first electric machine and/or to provide monitoring and electrical protection to the first electric machine;
a HP drive control unit configured to regulate electrical currents of the second electric machine and/or to provide monitoring and electrical protection to the second electric machine; and
a network and distribution control unit, configured to regulate network voltage and to apply power offtake orders and power injection orders received from an engine controller of the turbine engine.

32. The turbine engine according to claim 31, wherein the network and distribution control unit is arranged to configure the network and load power supply management, and to monitor electrical loads and currents in the networks and/or to protect the network from over loading or from over-currents.

33. The turbine engine according to claim 27, wherein the control system comprises:
a LP drive control unit configured to regulate electrical currents of the first electric machine and/or to provide monitoring and electrical protection to the first electric machine;
a HP drive control unit configured to regulate electrical currents of the second electric machine and/or to provide monitoring and electrical protection to the second electric machine; and
a voltage and power control unit, configured to regulate the network voltage and to apply power offtake orders and power injection orders received from an engine controller of the turbine engine.

34. The turbine engine according to claim 27, wherein the control system comprises:
a LP drive control unit configured to regulate electrical currents of the first electric machine and/or to provide monitoring and electrical protection to the first electric machine; and
a HP drive control unit configured to regulate electrical currents of the second electric machine and/or to provide monitoring and electrical protection to the second electric machine;
wherein regulation of the network voltage and/or application of power offtake orders and power injection orders received from an engine controller of the turbine engine is/are provided by at least one of the LP drive control unit and the HP drive control unit.

35. The turbine engine according to claim 34, wherein the control system further comprises a network and distribution control unit, arranged to configure the network and load power supply management, and to monitor and protect the network, and wherein the HP drive control unit is configured to directly communicate with the engine controller.

36. The turbine engine according to claim 27, wherein the control system comprises an engine start operating mode in which the control system is configured to supply power from the external electrical connection to at least one of the first and second electric machines via the high voltage DC busbar.

37. The turbine engine according to claim 36, wherein the control system is further configured to interrupt the power transfer between the first electric machine and the high voltage DC busbar when in the engine start operating mode.

38. The turbine engine according to claim 36, wherein the control system is further configured to supply power to the engine loads when in the engine start operating mode.

39. The turbine engine according to claim 27, wherein the control system comprises a power balance operating mode, and wherein the control system is configured to direct electrical power from the first and second electric machines to the engine loads and to the external electrical connection, via the high voltage DC busbar when in the power balance operating mode.

40. The turbine engine according to claim 27, wherein the control system comprises an engine restart operating mode, and wherein the control system is configured to transfer power from the first electric machine to the high voltage DC busbar and to transfer power from the high voltage DC busbar to the second electric machine when in the engine restart operating mode.

41. The turbine engine according to claim 40, wherein the control system is further configured to interrupt the power transfer between the high voltage DC busbar and the external electrical connection when in the engine restart operating mode.

42. The turbine engine according to claim 40, wherein the control system is further configured to supply power to the engine loads when in the engine restart operating mode.

43. The turbine engine according to claim 27, wherein the control system comprises a power transfer operating mode, and wherein the control system is configured to transfer power from a first of the first electric machine and the second electric machine to a second of the first electric machine and the second electric machine, via the high voltage DC busbar when in the power transfer operating mode.

44. The turbine engine according to claim 43, wherein the control system is configured to transfer power from the high voltage DC busbar to the engine loads and/or the external electrical connection when in the power transfer operating mode.

45. The turbine engine of claim 27, wherein the control system is configured to be switchable between two or more of a group of operating modes defined by:
an engine start operating mode in which the control system is configured to supply power from the external electrical connection to at least one of the first and second electric machines via the high voltage DC busbar;
a power balance operating mode in which the control system is configured to direct electrical power from the first and second electric machines to the engine loads and to the external electrical connection, via the high voltage DC busbar when in the power balance operating mode;
an engine restart operating mode in which the control system is configured to transfer power from the first electric machine to the high voltage DC busbar and to transfer power from the high voltage DC busbar to the second electric machine when in the engine restart operating mode; and
a power transfer operating mode in which the control system is configured to transfer power from a first of the first electric machine and the second electric machine to a second of the first electric machine and the second electric machine, via the high voltage DC busbar when in the power transfer operating mode.

46. The turbine engine according to claim 45, wherein the control system is configured to be switchable between all four operating modes of the group of operating modes.
